(19) United States
(12) Patent Application Publication
(10) Pub. No.: US 2007/0067572 A1
(43) Pub. Date: Mar. 22, 2007

(54) Buffering missed requests in processor caches

(75) Inventors: Yang Jiao, San Jose, CA (US); Yiping Chen, San Jose, CA (US); Wen-Chung Chen, Cupertino, CA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies, Inc.

(21) Appl. No.: 11/229,939

(22) Filed: Sep. 19, 2005

(51) Int. Cl. G06F 12/00

(52) U.S. Cl. 711/125

(57) ABSTRACT

The present disclosure relates to caches that are capable of improving processor performance. In some embodiments, among others, a cache request is received, and logic within the cache determines whether the received cache request results in a hit on the cache. If the cache request results in a hit on the cache, then that cache request is serviced. Conversely, if the cache request does not result in a hit (e.g., miss, miss-on-miss, hit-on-miss, etc.), then information related to the received cache request is stored in a missed request table. For some embodiments, missed read requests are stored in a missed read request table, while missed write requests are stored in a missed write request table.

### CROSS-REFERENCE TO RELATED APPLICATIONS

This application incorporates by reference, in their entireties, the following co-pending U.S. patent applications:

U.S. patent application Ser. No. [252009-1140], filed on Sep. 19, 2005 (under Express Mail Label No. EV 628221272), having the title “Selecting Multiple Threads for Substantially Concurrent Processing”; and

U.S. patent application Ser. No. [252009-1150], filed on Sep. 19, 2005 (under Express Mail Label No. EV 628221269), having the title “Merging Entries in Processor Caches.”

### FIELD OF THE DISCLOSURE

The present disclosure relates generally to processors and, more particularly, to caches associated with processors.

### BACKGROUND

Increasing complexity in software applications, such as in graphics processing, has led to an increased demand for hardware processing power. Part of modern-day processing architecture includes one or more caches, which are used to improve processing efficiency. Rather than accessing a main memory, which is external to a processor, caches are located within the processing unit itself, thereby permitting faster access to data and, concomitantly, permitting faster processing.

While various cache configurations have developed, there is still a continuing need to improve on those configurations.

### SUMMARY

The present disclosure relates to caches that are capable of improving processor performance. In some embodiments, among others, a cache request is received, and logic within the cache determines whether the received cache request results in a hit on the cache. If the cache request results in a hit on the cache, then that cache request is serviced. Conversely, if the cache request does not result in a hit (e.g., miss, miss-on-miss, hit-on-miss, etc.), then information related to the received cache request is stored in a missed request table.

For some embodiments, missed read requests are stored in a missed read request table, while missed write requests are stored in a missed write request table.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram showing an example processor environment.

FIG. 2 is a block diagram showing components within the computational core of FIG. 1.

FIG. 3 is a block diagram showing the level-2 (L2) cache of FIG. 2 in greater detail.

FIG. 4 is a block diagram showing components within the L2 cache of FIG. 3.

FIG. 5 is a block diagram showing several of the components of FIGS. 3 and 4 in greater detail.

FIG. 6 is an illustration of an L2 tag and data structure.

FIG. 7 is an illustration of a structure for an entry in a missed read-request table.

FIG. 8 is an illustration of a structure for an entry in a missed write-request table.

FIG. 9 is an illustration of a structure for an entry in a return data buffer.

FIG. 10 is an illustration of a structure for an entry in a return request queue.

FIG. 11 is a block diagram showing an embodiment of a hit test arbiter of FIGS. 4 and 5.

### DETAILED DESCRIPTION OF THE EMBODIMENTS

Reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

Most computer systems employ a cache, which is a small and fast memory that holds recently accessed data. Typically, the cache is designed to speed up subsequent access to the same data.

Generally, when data is read from, or written to, main memory a copy is also saved in the cache, along with the associated main memory address. The cache monitors addresses of subsequent reads to see if the required data is already in the cache. If the data is in the cache (referred to as a “cache hit”) then it is returned immediately and a read of the main memory is aborted or not started. If the data is not in the cache (referred to as a “cache miss”) then the data is fetched from main memory and also saved in the cache.

Typically, the cache is built from faster memory chips than main memory, so that a cache hit takes much less time to complete than a normal memory access. The cache may be located on the same integrated circuit (IC) as a central processing unit (CPU), thereby further reducing access time. Those caches that are located on the same IC as the CPU are often known as primary caches, since there may be larger, slower secondary caches (also known as level-2 (L2) caches) outside the CPU chip. For certain architectures, such as the ones disclosed herein, the caches can also be co-located on the same chip as the processing core, such as, for example, the graphics core of a graphics processing chip.

An important characteristic of a cache is its hit rate, which is the fraction of all memory accesses that are satisfied from the cache. The hit rate depends on the cache design, and often on the size of the cache relative to the size of the main memory. The size is limited by the on-chip cost of fast memory chips.

The hit rate also depends on the access pattern of the particular program being run (the sequence of addresses being read and written). Caches rely on two properties of the access patterns of most programs, namely, temporal locality and spatial locality. Temporal locality posits that if a particular data (or instruction) is accessed once, then it is likely to be accessed again relatively soon. Spatial locality posits that if one memory location is accessed, then nearby memory locations are also likely to be accessed. In order to exploit spatial locality, caches often operate on several words (referred to as “cache line” or “cache block”) at a time. Reads and writes of main memory are whole cache lines.

Generally, when the processor writes to main memory, the data is first written to the cache on the assumption that the processor will probably read it again soon. When the cache is full and another line of data is sought to be cached, a cache entry is selected to be written back to main memory or “flushed.” The new line is then put in its place. As one can imagine, it is generally desirable to have greater cache capacity, since this correspondingly reduces the number of main-memory reads or writes.

In order to accommodate greater cache efficiency, some embodiments of the invention provide for merging of cache requests. For those embodiments, requests are compared to determine whether there is a match between the requests. If the requests match, then the requests are merged, and the return destination identifier (ID) and address are recorded in a pending request queue. By merging requests that match, the cache increases its efficiency by not queuing duplicative requests.

For other embodiments, requests are compared with entries that are already in the pending request queue. If there is a match between a request and an entry, then the request is merged with the entry, thereby not queuing the request that is duplicative of a preexisting entry.

For yet other embodiments, latency within the cache is reduced by providing a missed read request table, which buffers cache read misses and permits cache read hits to pass through with little to no latency.

Yet other embodiments employ a missed write request table, which buffers cache write misses. The missed write request table, therefore, results in little to no latency in the event of a write miss.

It should be noted that, while the following description is framed in the context of a graphics processor, the principles described in the various embodiments can be applied to other types of processors that handle other types of data (e.g., non-graphics data).

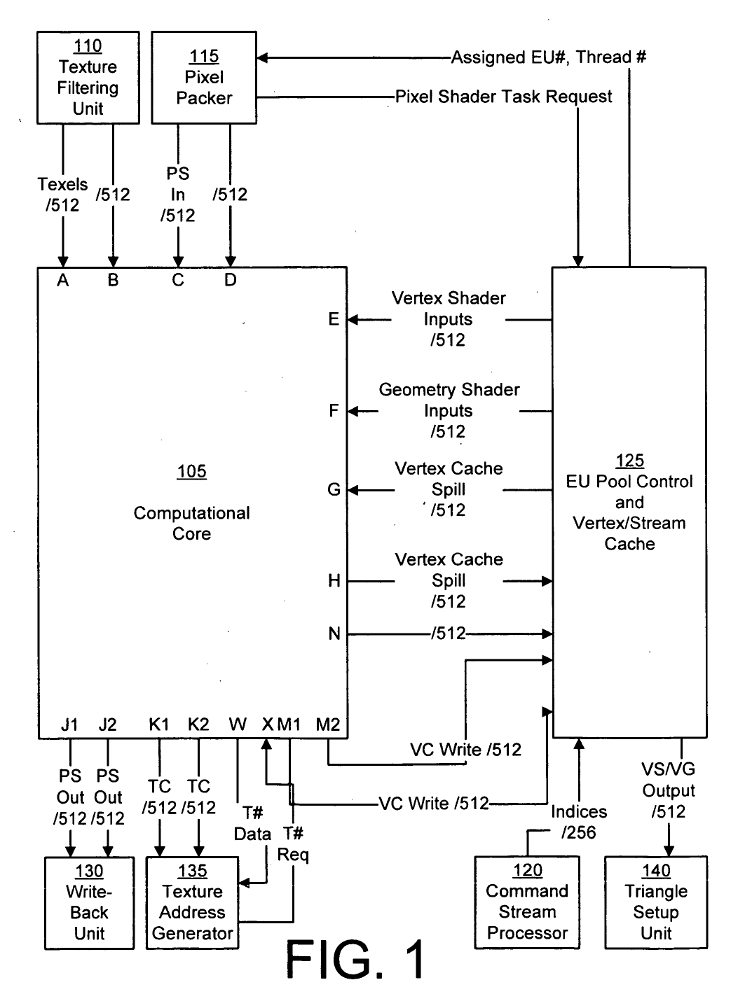

FIG. 1 is a block diagram showing an example processor environment for a graphics processor. While not all components for graphics processing are shown, the components shown in FIG. 1 should be sufficient for one having ordinary skill in the art to understand the general functions and architecture related to such graphics processors. At the center of the processing environment is a computational core 105, which processes various instructions. That computational core 105, for multi-issue processors, is capable of processing multiple instructions within a single clock cycle.

As shown in FIG. 1, the relevant components of the graphics processor include the computational core 105, a texture filtering unit 110, a pixel packer 115, a command stream processor 120, a write-back unit 130, and a texture address generator 135. Also included in FIG. 1 is an execution unit (EU) pool control unit 125, which also includes a vertex cache and/or a stream cache. The computational core 105 receives inputs from various components and outputs to various other components.

For example, as shown in FIG. 1, the texture filtering unit 110 provides texel data to the computational core 105 (inputs A and B). For some embodiments, the texel data is provided as 512-bit data, thereby corresponding to the data structures defined below.

The pixel packer 115 provides pixel shader inputs to the computational core 105 (inputs C and D), also in 512-bit data format. Additionally, the pixel packer 115 requests pixel shader tasks from the EU pool control unit 125, which provides an assigned EU number and a thread number to the pixel packer 115. Since pixel packers and texture filtering units are known in the art, further discussion of these components is omitted here. While FIG. 1 shows the pixel and texel packets as 512-bit data packets, it should be appreciated that the size of the packets can be varied for other embodiments, depending on the desired performance characteristics of the graphics processor.

The command stream processor 120 provides triangle vertex indices to the EU pool control unit 125. In the embodiment of FIG. 1, the indices are 256-bits. The EU pool control unit 125 assembles vertex shader inputs from the stream cache and sends data to the computational core 105 (input E). The EU pool control unit 125 also assembles geometry shader inputs and provides those inputs to the computational core 105 (input F). The EU pool control 125 also controls the EU input 235 and the EU output 220. In other words, the EU pool control 125 controls the respective inflow and outflow to the computational core 105.

Upon processing, the computational core 105 provides pixel shader outputs (outputs J1 and J2) to the write-back unit 130. The pixel shader outputs include red/green/blue/alpha (RGBA) information, which is known in the art. Given the data structure in the disclosed embodiment, the pixel shader output is provided as two 512-bit data streams.

Similar to the pixel shader outputs, the computational core 105 outputs texture coordinates (outputs K1 and K2), which include UVRQ information, to the texture address generator 135. The texture address generator 135 issues a texture request (T# Req) to the computational core 105 (input X), and the computational core 105 outputs (output W) the texture data (T# data) to the texture address generator 135. Since the various examples of the texture address generator 135 and the write-back unit 130 are known in the art, further discussion of those components is omitted here. Again, while the UVRQ and the RGBA are shown as 512 bits, it should be appreciated that this parameter may also be varied for other embodiments. In the embodiment of FIG. 1, the bus is separated into two 512-bit channels, with each channel holding the 128-bit RGBA color values and the 128-bit UVRQ texture coordinates for four pixels.

The computational core 105 and the EU pool control unit 125 also transfer to each other 512-bit vertex cache spill data. Additionally, two 512-bit vertex cache writes are output from the computational core 105 (outputs M1 and M2) to the EU pool control unit 125 for further handling.

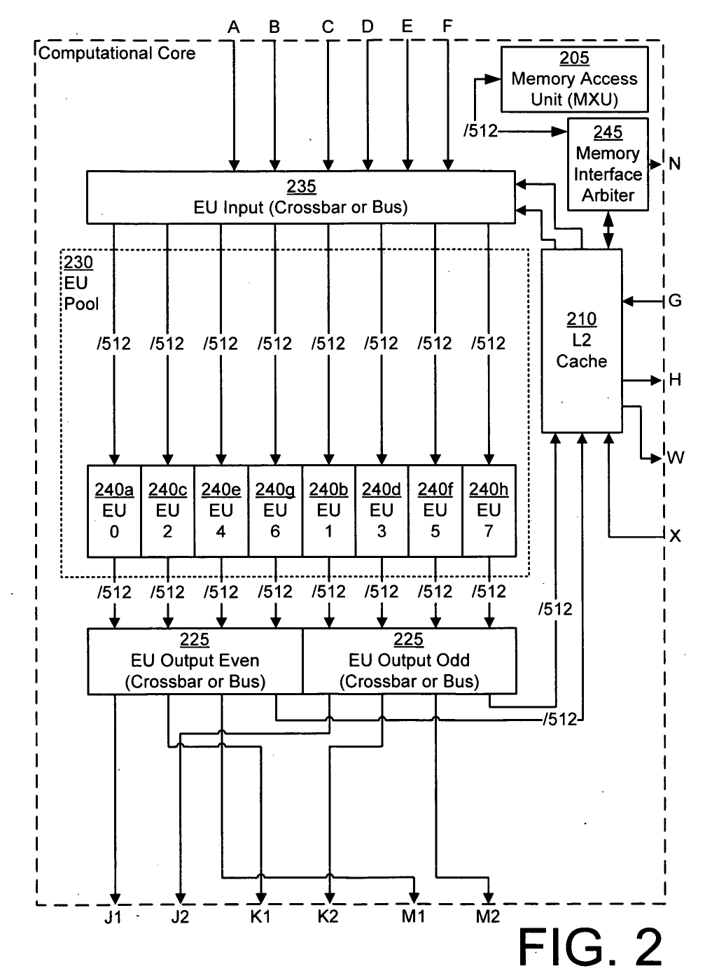

Having described the data exchange external to the computational core 105, attention is turned to FIG. 2, which shows a block diagram of various components within the computational core 105. As shown in FIG. 2, the computational core 105 comprises a memory access unit 205 that is coupled to a level-2 (L2) cache 210 through a memory interface arbiter 245.

The L2 cache 210 receives vertex cache spill (input G) from the EU pool control unit 125 (FIG. 1) and provides vertex cache spill (output H) to the EU pool control unit 125 (FIG. 1). Additionally, the L2 cache receives T# requests (input X) from the texture address generator 135 (FIG. 1), and provides the T# data (output W) to the texture address generator 135 (FIG. 1) in response to the received request.

The memory interface arbiter 245 provides a control interface to the local video memory (frame buffer). While not shown, a bus interface unit (BIU) provides an interface to the system through, for example, a PCI express bus. The memory interface arbiter 245 and BIU provide the interface between the memory and an execution unit (EU) pool L2 cache 210. For some embodiments, the EU pool L2 cache connects to the memory interface arbiter 245 and the BIU through the memory access unit 205. The memory access unit 205 translates virtual memory addresses from the L2 cache 210 and other blocks to physical memory addresses.

The memory interface arbiter 245 provides memory access (e.g., read/write access) for the L2 cache 210, fetching of instructions/constants/data/texture, direct memory access (e.g., load/store), indexing of temporary storage access, register spill, vertex cache content spill, etc.

The computational core 105 also comprises an execution unit pool 230, which includes multiple execution units (EUs) 240a . . . 240h (collectively referred to herein as 240), each of which includes an EU control and local memory (not shown). Each of the EUs 240 are capable of processing multiple instructions within a single clock cycle. Thus, the EU pool 230, at its peak, can process multiple threads substantially simultaneously. These EUs 240, and their substantially concurrent processing capacities, are described in greater detail below. While eight (8) EUs 240 are shown in FIG. 2 (labeled EU0 through EU7), it should be appreciated that the number of EUs need not be limited to eight, but may be greater or fewer in number for other embodiments.

The computational core 105 further comprises an EU input 235 and an EU output 220, which are respectively configured to provide the inputs to the EU pool 230 and receive the outputs from the EU pool 230. The EU input 235 and the EU output 220 may be crossbars or buses or other known input mechanisms.

The EU input 235 receives the vertex shader input (E) and the geometry shader input (F) from the EU pool control 125 (FIG. 1), and provides that information to the EU pool 230 for processing by the various EUs 240. Additionally, the EU input 235 receives the pixel shader input (inputs C and D) and the texel packets (inputs A and B), and conveys those packets to the EU pool 230 for processing by the various EUs 240. Additionally, the EU input 235 receives information from the L2 cache 210 (L2 read) and provides that information to the EU pool 230 as needed.

The EU output in the embodiment of FIG. 2 is divided into an even output 225a and an odd output 225b. Similar to the EU input 235, the EU output 225 can be crossbars or buses or other known architectures. The even EU output 225a handles the output from the even EUs 240a, 240c, 24e, 240g, while the odd EU output 225b handles the output from the odd EUs 240b, 240d, 240f, 240h. Collectively, the two EU outputs 225a, 225b receive the output from the EU pool 230, such as the UVRQ and the RGBA. Those outputs, among others, may be directed back to the L2 cache 210, or output from the computational core 105 to the write-back unit 130 (FIG. 1) through J1 and J2 or output to the texture address generator 135 (FIG. 1) through K1 and K2.

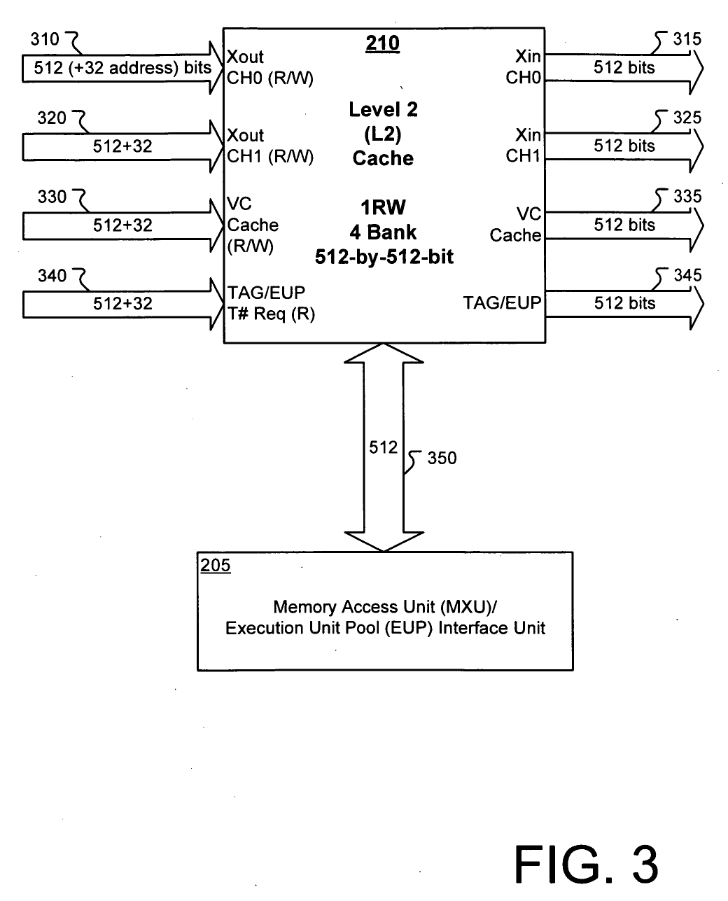

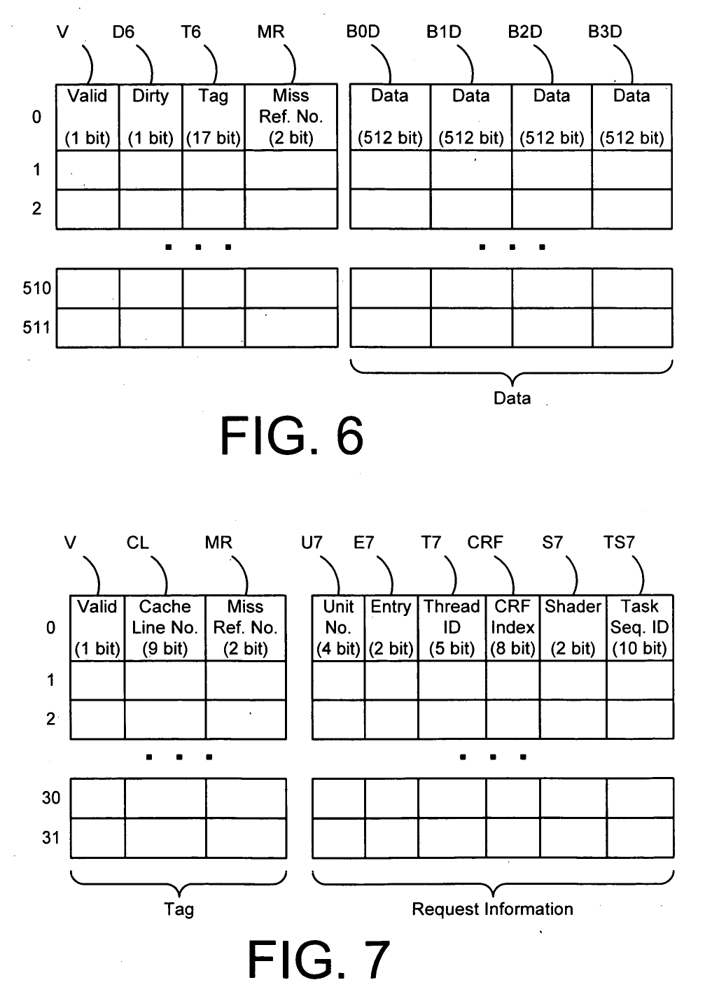

FIG. 3 is a block diagram showing the L2 cache 210 of FIG. 2 in greater detail. For some embodiments, the L2 cache 210 uses four banks of 1RW 512×512-bit memories, and the total size of the cache is 1M-bits. In the embodiment of FIG. 3, the L2 cache 210 has 512 cache lines, and the line size is 2048 bits. The cache line is divided into four 512-bit words, each on a different bank. In order to access the data, an addressing scheme is provided, which designates the proper virtual memory address space for the respective data. An example data structure for the L2 cache 210 is provided with reference to FIG. 6.

For some embodiments, the address may have a 30-bit format that is aligned to 32-bits. Various portions of the address can be specifically allocated. For example, bits [0:3] can be allocated as offset bits; bits 4 through 5 (designated as [4:5]) can be allocated as word-select bits; bits [6:12] can be allocated as line-select bits; and bits [13:29] can be allocated as tag bits.

Given such 30-bit addresses, the L2 cache 210 can be a four-way set-associative cache, for which the sets are selected by the line-select bits. Also, the word can be selected with the word-select bits. Since the example data structure has 2048-bit line sizes, the L2 cache 210 can have four banks, with each bank having 1RW 512-bit port, for up to four read/write (R/W) accesses for each clock cycle. It should be appreciated that, for such embodiments, the data in the L2 cache 210 (including the shader program code, constants, thread scratch memories, the vertex cache (VC) content, and the texture surface register (T#) content) can share the same virtual memory address space.

An example embodiment is provided with reference to FIG. 3, which shows an L2 cache 210 having four inputs 310, 320, 330, 340 and four outputs 315, 325, 335, 345. For this embodiment, one input (Xout CH0 310) receives 512-bit data from one channel (CH0) of the EU output 220 crossbar, and another input (Xout CH1 320) receives 512-bit data from another channel (CH1) of the EU output 220 crossbar. The third and fourth inputs (VC cache 330 and T# Req 340) each receive 512-bit-aligned vertex data from VC and T# registers, respectively. As shown in FIG. 3, the 512-bit data also has a 32-bit address associated with the data.

The outputs include a 512-bit output (Xin CH0 315) for writing data to the EU input 235 crossbar, and a 512-bit output (Xin CH1 325) for writing data to the EU input 235 crossbar. Also, 512-bit outputs (VC cache 335 and TAG/EUP 345) are provided for writing data to the VC and T# registers, respectively.

In addition to the four inputs 310, 320, 330, 340 and the four outputs 315, 325, 335, 345, the L2 cache 210 includes an external R/W port 350 to the memory access unit 205. For some embodiments, the external write to the memory access unit 205 is given higher priority than other R/W requests. The EU load instruction (designated herein as “LD4/8/16/64”) loads 32/64/128/512-bit data, which is correspondingly aligned to 32/64/128/512-bit memory addresses. For the load instruction, the returned 32/64/128-bit data is replicated to 512 bits. The 512-bit data is masked by the valid pixel or vertex mask and channel mask when the data is written into the EU register file (also referred to herein as the “common register file” or “CRF”). Similarly, the EU store instruction (designated herein as “ST4/8/16/64”) stores 32/64/128/512-bit data, which is correspondingly aligned to 32/64/128/512-bit memory addresses.

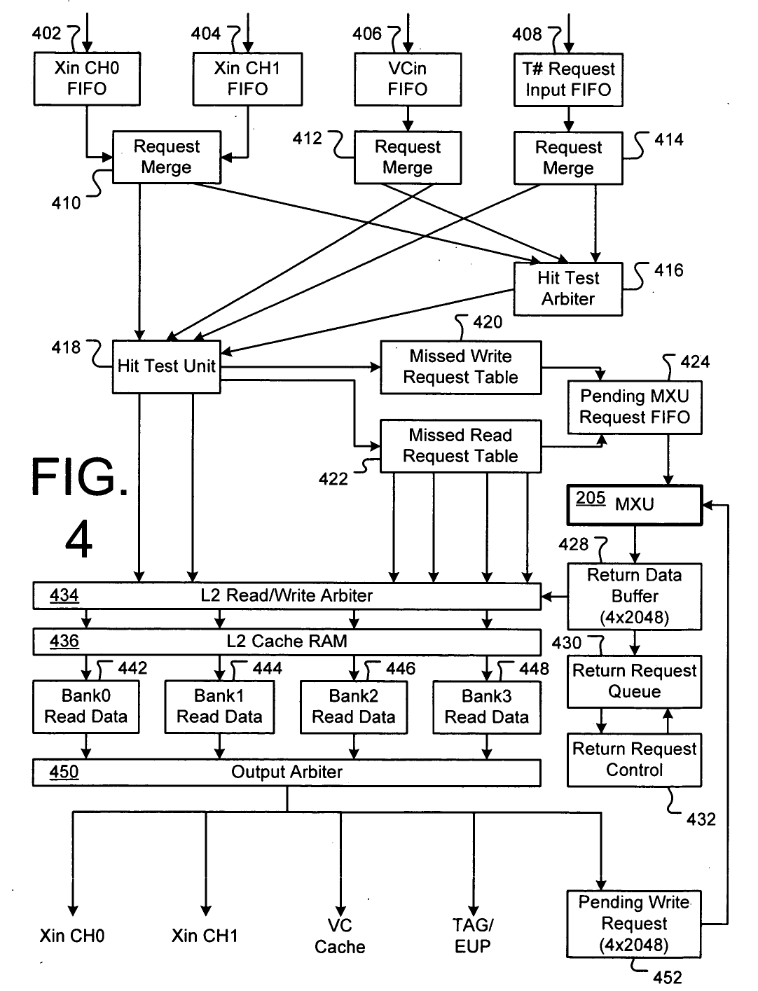

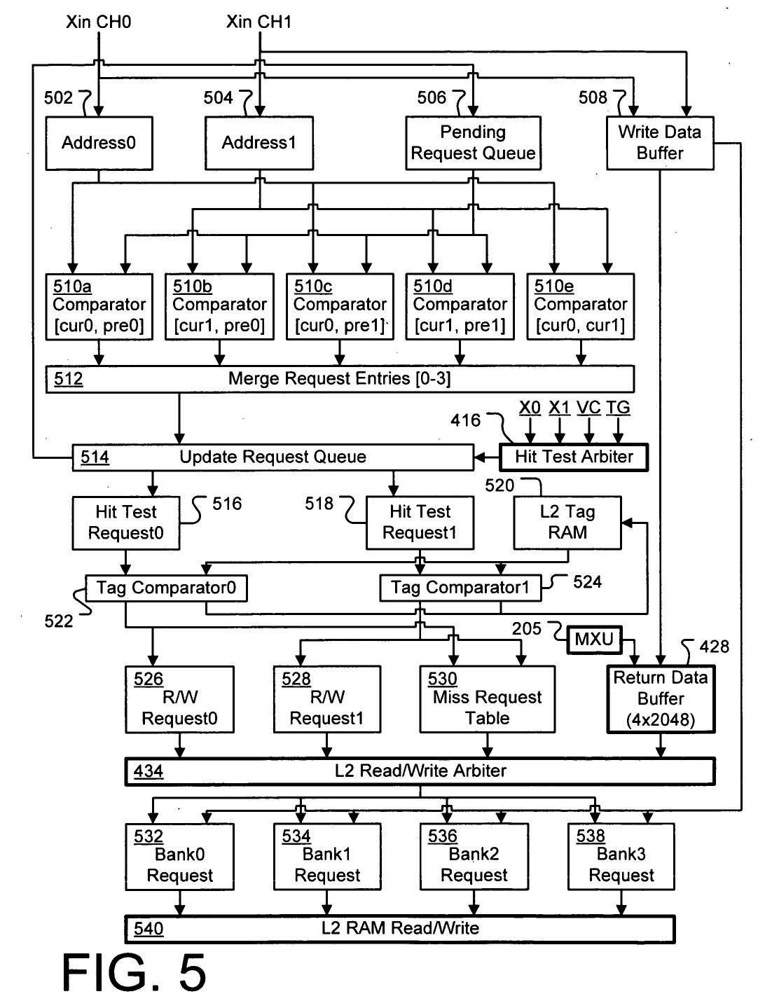

Given such data structures, all other read/write requests (e.g., instructions and constants from the EU, vertex data from the vertex cache, texture data from the T# registers, etc.) are aligned to 512-bit memory addresses. Various components of the L2 cache 210 are shown in greater detail with reference to FIGS. 4 and 5. Additionally, embodiments of various entry structures and/or data structures for use with the L2 cache 210 are shown with reference to FIGS. 6 through 10.

As shown in FIG. 6, the L2 data structure comprises a 1-bit valid flag (V), a 1-bit dirty flag (D6), a 17-bit tag (T6), and a 2-bit miss reference number (MR), all of which identify an address for a particular data set. In addition to these address bits, the data structure includes four 512-bit entries, totaling 2048 bits. The L2 cache 210, for this embodiment, permits up to 512 entries.

FIG. 4 is a block diagram showing various components within the L2 cache 210 of FIG. 3. The input data from Xout CH0 310 and Xout CH1 320 of FIG. 3 enter through their respective first-in-first-out (FIFO) stacks, correspondingly labeled in FIG. 4 as Xin CH0 FIFO 402 and Xin CH1 FIFO 404. Similarly, data that is entering through the VC cache input 330 is placed in the VCin FIFO 406, while the data entering through the T# request input 340 is placed in the T# request FIFO 408.

The Xin CH0 FIFO 402 and the Xin CH1 FIFO 404 direct their respective incoming requests to request merge logic 410. The request merge logic 410 determines whether or not the incoming requests from these respective FIFOs should be merged. Components of the request merge logic 410 are shown in greater detail with reference to FIG. 5. The VCin FIFO 406 and the T# request FIFO 408 similarly direct their respective requests to corresponding request merge logic 412, 414.

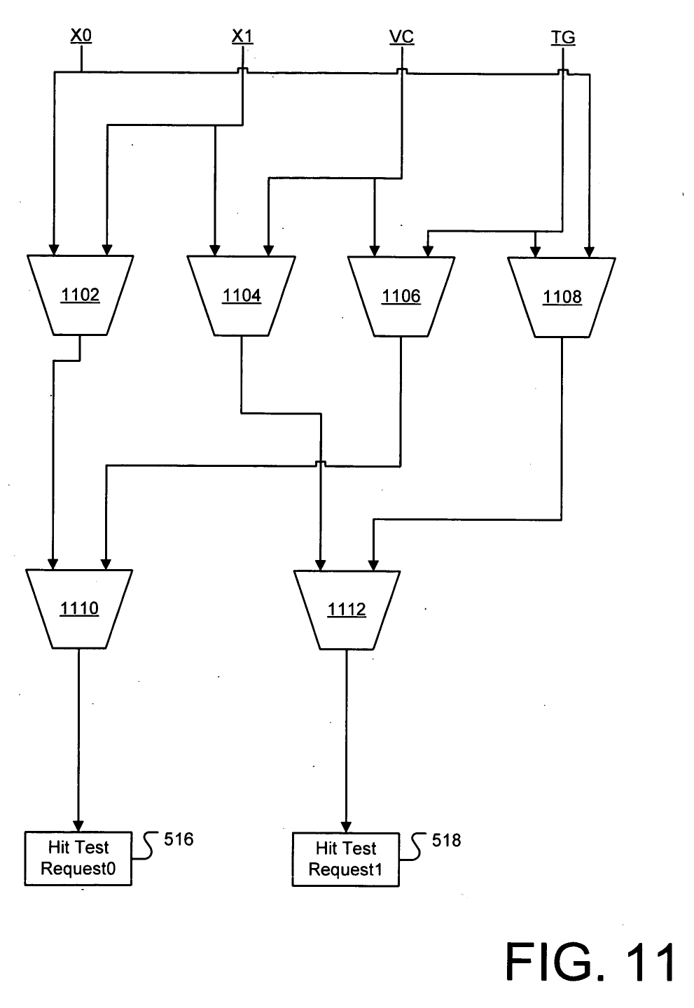

The resulting outputs of the request merge logic 410, 412, 414 are conveyed to hit test arbiter 416. The hit test arbiter 416 determines whether there is a hit or a miss on the cache. For some embodiments, the hit test arbiter 416 employs barrel shifters with independent control of shift multiplexers (MUXes 1102, 1104, 1106, 1108, 1110, 1112) as shown in FIG. 11. However, it should be appreciated that other embodiments can be configured using, for example, bi-directional leading one searching, or other known methods.

The results of the hit test arbitration from the hit test arbiter 416, along with the resulting outputs of the request merge logic 410, 412, 414, are conveyed to the hit-test unit 418. Given the configuration of FIG. 11, there are up to two requests sent to the hit test unit 418 for every clock cycle. Preferably, the two requests should neither be on the same cache line nor in the same set. The hit test arbiter and the various components of the hit test unit 418 are discussed in greater detail with reference to FIG. 5.

The L2 cache 210 further comprises a missed write request table 420 and a missed read request table 422, which both feed into a pending memory access unit (MXU) request FIFO 424. The pending MXU request FIFO 424 further feeds into the memory access unit 205. The pending MXU request FIFO 424 is described in greater detail below, with reference to hit-testing of the L2 cache 210.

The return data from the MXU 205 is placed in a return data buffer 428, which conveys the returned data to an L2 read/write (R/W) arbiter 434. Requests from the hit test unit 418 and the read requests from the missed read request table 422 are also conveyed to the L2 R/W arbiter 434. Once the L2 R/W arbiter 434 arbitrates the requests, the appropriate requests are sent to the L2 cache RAM 436. The return data buffer 428, the missed read request table 422 420, the missed write request table 420 422, the L2 R/W arbiter 434, and the L2 cache RAM 436 are discussed in greater detail with reference to FIG. 5.

Given the four-bank structure of FIG. 6, the L2 cache RAM 436 outputs to four read banks 442, 444, 446, 448, which, in turn, output to an output arbiter 450. Preferably, the output arbiter 450 arbitrates in round-robin fashion the returned data of the read requests (Xin CH0 and Xin CH1), the VC, and the T#. Given that each entry may hold four requests, it can take up to four cycles to send data to the appropriate destination before the entry is removed from the output buffer.

FIG. 5 is a block diagram showing several of the components of FIGS. 3 and 4 in greater detail. Specifically, FIG. 5 shows the components related to the merge request and the hit test stages within the L2 cache 210. While the description of FIG. 5 presumes the data structure described above, it should be appreciated that the particular values for various registers can be varied without deviating from the spirit and scope of the inventive concept.

Recalling from the data structure described above, the incoming data to the L2 cache 210 comprises a 32-bit address portion and a 512-bit data portion. Given this, the incoming requests, Xin CH0 and Xin CH1, are each divided into two portions, namely, a 32-bit address portion and a 512-bit data portion. The 32-bit address portion for Xin CH0 is placed in the buffer address0 502, while the 512-bit Xin CH0 data is placed in the write data buffer 508. The write data buffer 508, for this embodiment, holds up to four entries. Similarly, the 32-bit address portion for Xin CH1 is placed in the buffer address1 504, and the 512-bit Xin CH1 data is placed in the write data buffer 508.

If there are any pending entries, then those pending entries are held in the pending request queue 506. In order to determine whether or not various requests (or entries) can be merged, the various addresses in the pending request queue 506 are compared with the addresses in buffers address0 502 and address1 504. For some embodiments, five comparators 510a . . . 510e are employed to compare different permutations of addresses. These comparators 510a . . . 510e identify whether or not the entries within those buffers can be merged.

Specifically, in the embodiment of FIG. 5, a first comparator 510a compares a current address for the Xin CH0 data (designated as “cur0” for simplicity), which is in the address0 buffer 502, with a previous address for Xin CH0 (designated as “pre0”), which is in the pending request queue 506. If the request cur0 matches with the entry pre0, then the request and the entry are merged by the merge request entries logic 512. The return destination ID and address of the merged entries are recorded in the pending request queue 506 by the update request queue logic 514.

A second comparator 510b compares a current address for the Xin CH1 data (designated as “cur1”), which is in the address1 buffer 504, with pre0. If cur1 matches pre0, then the merge request entries logic 512 merges cur1 with pre0, and the update request queue logic 514 updates the pending request queue 506 with the return destination ID and address of the merged entry or request.

A third comparator 510c compares cur0 with a previous address for Xin CH1 (designated as “pre1”). If cur0 and pre1 match, then the merge request entries logic 512 merges cur0 with pre1, and the update request queue logic 514 updates the pending request queue 506 with the return destination ID and address of the merged entry or request.

A fourth comparator 501d compares cur1 and pre1. If there is a match between cur1 and pre1, then cur1 and pre1 are merged by the merge request entries logic 512. The pending request queue 506 is then updated by the update request queue logic 514 with the return destination ID and address of the merged entry or request.

If none of the previous entries (pre0 and pre1) in the queue match the incoming request (cur0 and cur1), then a new entry is added into the queue.

A fifth comparator 510e compares cur0 and cur1 to determine if the two incoming requests match. If the two incoming requests are on the same cache line, then those incoming requests are merged by the merge request entries logic 512. In other words, if the two incoming requests match, then they are merged. The destination ID and address of the merged requests are updated in the pending request queue 506 by the update request queue logic 514.

Since the embodiment of FIG. 5 compares four addresses (cur0, cur1, pre0, pre1), the merge request entries logic 512 for this embodiment can hold up to four entries, each having a unique address. Also, it should be noted that, while the pending request queue 506 can hold up to four entries, only the first two entries are compared with current requests in the embodiment of FIG. 5. Thus, for this embodiment, if there are more than two entries in the queue, the L2 will stop receiving requests from the EU output (or crossbar) 220.

As noted above, L2 cache 210 also includes a write data buffer 508, which holds write request data from the crossbar 220. For the embodiment of FIG. 5, the write data buffer 508 holds up to four data entries. When the buffer is full, the L2 cache 210 stops receiving requests from the crossbar 220. A pointer to the buffer is recorded in the request address entry, which is later used to load the write request data into the L2 cache RAM 436.

The L2 cache 210 of FIG. 5 further comprises a hit test arbiter 416. The hit test arbiter 416 selects two valid entries (X0 and X1) from the Xin FIFOs 402, 404, one entry (VC) from the VCin FIFO 406, and one entry (TG) from the T# request input FIFO 408. This selection is based on an availability status from the previous cycle. Preferably, the two entries should not be selected from the same set. The result of arbitration is passed to the update request queue logic 514, and the selected entries are updated to include any request that has been merged in the current cycle. The entries are then removed accordingly from the pending request queue 506, and sent to the next stage for hit testing. The pending request queue 506 is updated to include merged requests in the current cycle and to remove entries that are sent to the next stage for hit testing.

As described with reference to FIGS. 4 and 11, the hit test arbitration scheme can employ barrel shifters with independent control of shift MUXes, but can also be implemented using other known techniques. Given the configuration of FIG. 11, there can be up to two requests (hit test request0 516 and hit test request1 518) that are sent to the hit test unit 418 at every cycle. Preferably, the two requests should neither be on the same cache line nor in the same set. Since, for this embodiment, there is only one request for each set, no complicated least-recently used (LRU) and replacement scheme are necessary. Bits [6:12] of the 30-bit address can be used as an index to look up four tags from an L2 tag RAM 520, and the 17 most significant bits (MSBs) of the address can be compared with the four tags to find a match.

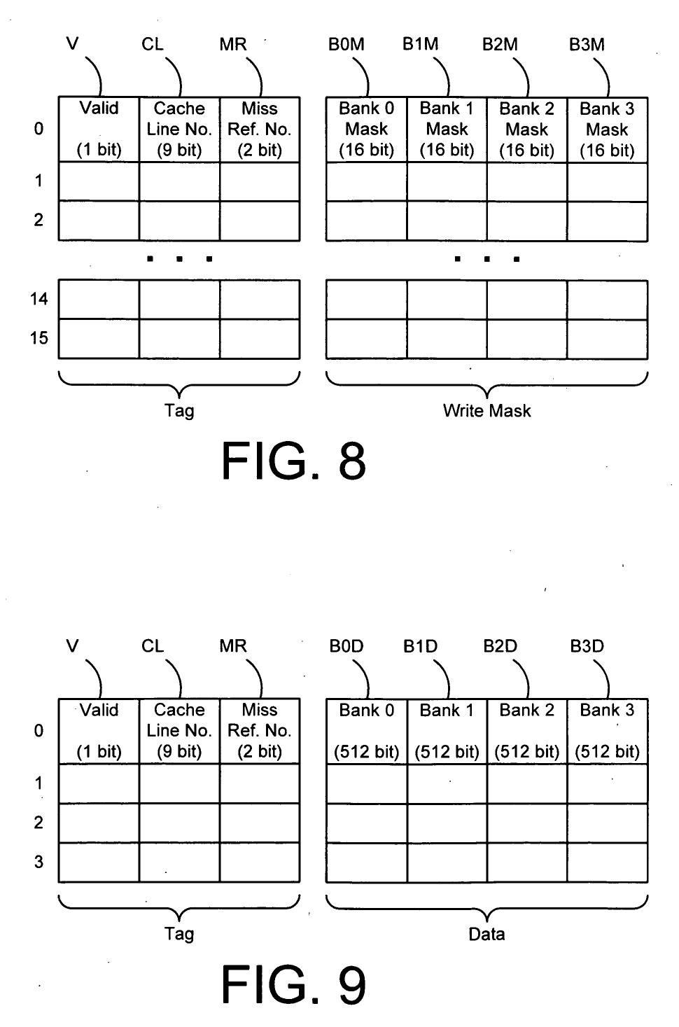

If there is a hit on the L2 cache 210, then the address is sent to the next stage along with the word selections, offsets, return destination IDs, and addresses of up to four requests attached to the hit test entry. If there is a miss on the L2 cache 210, then the line address and other request information is written into a 64-entry miss request table 530. Similarly, if there is a hit-on-miss (described below), then the line address and other request information is written into the 64-entry miss request table 530. Data structures for both a missed read request table 422 and a missed write request table 420 are discussed in greater detail with reference to FIGS. 7 and 8, respectively. This hit test arbitration scheme preferably allows for pipeline stalls if there is any back-pressure from subsequent stages within the L2 cache 210.

FIG. 7 is an illustration of a structure for an entry in a missed read request table 422. The missed read request table 422, within the L2 cache 210, records misses in the L2 cache 210. In that regard, the L2 cache 210 can continuously receive requests, despite the existence of a read miss on the L2 cache 210. As described in greater detail below, a missed read request is placed in the missed read request table 422, and a main memory request is issued. When the main memory request returns, the missed read request table 422 can be searched to find the return address. Thus, the new return address is obtained without storing the cache.

Unlike the missed read request table 422, conventional caches often employ a latency FIFO. Such latency FIFOs place all requests within the FIFO. Thus, regardless of whether or not there is a hit on the cache, all of the requests are directed through the latency FIFO in conventional caches. Unfortunately, in such conventional latency FIFOs, all requests will wait for the entire cycle of the latency FIFO regardless of whether or not those requests are hits or misses. Thus, for a latency FIFO (which is about 200 entries deep), a single read miss can result in undesired latency for subsequent requests. For example, if there is a first read miss on cache line 0, but read hits on cache lines 1 and 2, then, for a latency FIFO, the read requests on cache lines 1 and 2 must wait until the read request on cache line 0 clears the latency FIFO before the cache realizes that there is a read miss.

The missed read request table 422 permits pass-through buffering of hit read requests, despite the presence of missed read requests. Thus, when there is a read miss on the L2 cache 210, that read miss is buffered through the missed read request table 422, and all other read requests are passed through. For example, if there is a first read miss on cache line 0, but read hits on cache lines 1 and 2, then, for the missed read request table 422, the read miss on cache line 0 is buffered to the missed read request table 422, while the read requests on cache lines 1 and 2 are passed through the L2 cache 210. Specific embodiments of the missed read request table 422 are provided below.

In the embodiment of FIG. 7, the missed read request table 422 permits 32 entries. Each entry is divided into a 12-bit tag and 31-bit request information. The tag includes a 1-bit valid/invalid flag (V), a 9-bit cache line number (CL), and a 2-bit miss reference number (MR). The request information, for this embodiment, includes a 4-bit destination unit ID number (U7), a 2-bit entry type (E7), a 5-bit thread ID (T7), an 8-bit register file index (CRF), a 2-bit shader information (S7), and a 10-bit task sequence ID (TS7).

If there is a read miss in the L2 cache 210, the missed read request table 422 is searched, and a free entry is selected to store the CL and other information related to the request (e.g., U7, E7, T7, CRF, S7, TS7, etc.). In addition to storing the CL and other related information, the 2-bit miss pre-counter (MR) of the selected cache line is incremented, and the value of the counter is copied into the table entry.

If there is a read hit in the L2 cache 210, and the pre-counter and post-counter are not equal (“hit-on-miss”), then a new entry is created in the missed read request table 422. For the hit-on-miss, the pre-counter of the selected cache line is not incremented.

If there is a read hit on the L2 cache 210, and the pre-counter equals the post-counter (“hit”), then no new entry is created in the missed read request table 422, and the request is sent directly for read by the L2 cache RAM 436.

FIG. 8 is an illustration of a structure for an entry in a missed write request table 420. Unlike a missed read request, a missed write request is relatively large, since a write request includes both an address and corresponding data to be written. Due to the size of the write request, there is a substantial cost associated with storing all of the missed write requests. Conversely, if too little is buffered, then problems associated with stolen cache may arise.

Conventional caches typically provide for write-through, which accesses external memory to retrieve the data associated with the write miss. Unfortunately, such write-through mechanisms result in added data traffic to and from the memory. This added data traffic is relatively inefficient.

Unlike conventional write-through mechanisms, the missed write request table 420 of FIG. 8 permits storage of the address of the missed write request within the L2 cache 210 itself, along with a mask that flags that data as being dirty. Thus, the data is locally kept on the L2 cache 210. When the data is flagged as dirty, that dirty line is replaced with another write request having the same data. For example, when a mask for a dirty line is stored in the L2 cache 210, that mask is compared with subsequent write requests during the hit-testing stage. If the stored mask matches a write request, then the new data replaces the data from the previously missed write request. Specific embodiments of the missed write request table 420 are provided below.

In the embodiment of FIG. 8, the missed write request table 420 permits 16 entries. Each entry is divided into a 12-bit tag and a 64-bit write mask. The 12-bit tag of the missed write request table 420, for this embodiment, is identical to the 12-bit tag of the missed read request table 422. In that regard, the 12-bit tag includes a 1-bit valid/invalid flag (V), a 9-bit cache line number (CL), and a 2-bit miss reference number (MR). The write mask, for this embodiment, includes four 16-bit masks, one for each of the banks (bank 0 mask (B0M), bank 1 mask (B1M), bank 2 mask (B2M), and bank 3 mask (B3M)).

If there is a write miss in the L2 cache 210, then the missed write request table 420 is searched, and a free entry is selected to store the cache line address (CL) and a corresponding update write mask. The 2-bit miss pre-counter (MR) of the selected cache line is incremented, and the value of the counter is copied into the missed write request table 420.

If the miss pre-counter is equal to the miss post-counter before the increment (“first-write-miss”), then the write data is sent to the L2 cache RAM 436 directly, along with the original write mask. If the miss pre-counter is not equal to the miss post-counter before the increment (“miss-on-miss”), then the return data buffer 428 is searched to find a free entry to hold the write data. The structure of the return data buffer 428 is described in greater detail with reference to FIG. 9, below.

If there is a write hit in the L2 cache 210, and the pre-counter is unequal to the post-counter (“hit-on-miss”), then the missed write request table 420 is searched to find a matched entry with the same cache line address (CL) and miss count (MR). If such an entry is found, then the update write mask is merged with the original write mask that is found in the missed write request table 420.

Concurrent with the searching of the missed write request table 420, the return data buffer 428 is searched for an entry with the same cache line address (CL) and miss count (MR). If such a match is found in the return data buffer 428 (“hit-on-miss-on-miss”), then the write data is sent to the return data buffer 428. However, if no such match is found in the return data buffer 428 (“hit-on-miss”), then the write data is sent to the L2 cache RAM 436, along with the merged update write mask.

If there is a write hit in the L2 cache 210, and the pre-counter equals the post counter (“write hit”), then the write data is sent to the L2 cache RAM 436 directly, along with the original write mask. For all write hit requests, the miss pre-counter (MR) is not incremented.

For some embodiments, if a replaced line in a read miss or a write miss is dirty, then the hit test unit 418 first issues a read request to read the dirty line from the MXU 205. Thereafter, the write data is sent during the next cycle.

After the hit test arbitration stage, various entries and requests are arbitrated and sent to the L2 cache RAM 436. These entries include read/write requests from the hit test stage, read requests from a miss request FIFO, and write requests from the MXU 205. In the event that requests from different sources go to the same bank in the same cycle, the MXU write request has the highest priority in this embodiment. Also, for this embodiment, the miss request FIFO has the second highest priority, and the hit test results have the lowest priority. As long as requests from the same source are directed to different banks, those requests can be arranged out of order in order to maximize throughput.

For some embodiments, the output arbitration on the return data can be performed in a round-robin fashion by the output arbiter 450. For such embodiments, the returned data can include the read requests from the crossbar (Xin CH0 and Xin CH1), the read request from the vertex cache (VC), and the read request from the T# registers (TAG/EUP). Since, as noted above, each entry can hold up to four requests, it can take up to four cycles to send the data to the appropriate destinations before the entry is removed from the output buffer.

Upon a cache miss, a request to the MXU 205 is sent to the pending MXU request FIFO 424. For some embodiments, the pending MXU request FIFO 424 includes up to 16 pending request entries. In the embodiments of FIGS. 4 and 5, the L2 cache 210 permits up to four write requests (out of the 16 total pending request entries) to the memory. For read requests, the 9-bit return L2 cache line address (LC) and the 2-bit miss reference count number (MR) are sent to the MXU 205, along with the virtual memory address. The LC and MR can later be used to search for the entry in the missed read request table 422, when the data is returned from the MXU 205.

FIG. 9 is an illustration of a structure for an entry in the return data buffer 428. In the embodiment of FIG. 9, the return data buffer 428 includes up to four slots (0, 1, 2, 3). Each of the four slots is divided into a 12-bit tag and a 2048-bit data portion. The 12-bit tag of the return data buffer 428, for this embodiment, is identical to the 12-bit tag for both the missed read request table 422 and the missed write request table 420. In that regard, the 12-bit tag includes a 1-bit valid/invalid flag (V), a 9-bit cache line number (CL), and a 2-bit miss reference number (MR). The 2048-bit data portion, for this embodiment, includes four 512-bit banks (bank 0 (B0D), bank 1 (B1D), bank 2 (B2D), and bank 3 (B3D)). For some embodiments, the first slot (0) is used for bypass, while the remaining slots (1, 2, 3) are used for miss-on-miss requests.

Upon an L2 cache write miss, if the pre-counter and post-counter numbers are not equal prior to increment (“miss-on-miss”), then the return data buffer 428 is searched to find a free entry to hold the partial write data. Upon an L2 cache read miss-on-miss, the return data buffer 428 is searched to find a free entry to receive the returned data from the MXU 205. The selected entries are marked with the cache address line number (CL) and a miss pre-count (MR). If all three slots (1, 2, 3) for miss-on-miss requests have been allocated, then the hit-testing stage will, for some embodiments, be stopped.

When returned data from the MXU 205 arrives in the return data buffer 428, the three slots (1, 2, 3) are searched to find a match with the same cache address line number (CL) and miss count (MR). If none of those match the incoming returned data, then the incoming returned data is stored in the bypass slot (0). That stored data is then sent to the L2 cache RAM 436 during the next cycle, along with the update write mask specified in the missed write request table 420. If, however, a match is found, then the data is merged with the entries in the buffer according to the update write mask for a write-miss-initiated memory request. It should be noted that the data is filled in the buffer directly for a read-miss-initiated memory request.

For some embodiments, the order written to the L2 cache 210 is kept as only for the data that has the same cache address. Other data for different cache lines is written into the L2 cache when that data becomes ready.

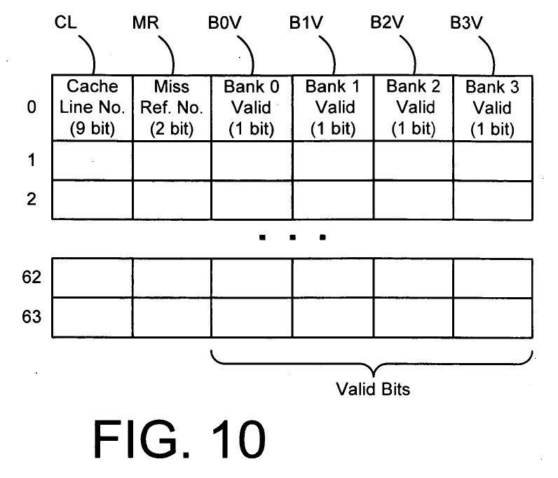

FIG. 10 is an illustration of a structure for an entry in a return request queue 430. In the embodiment of FIG. 10, the return request queue 430 includes up to 64 entries. Each of the 64 entries, for this embodiment, includes a 9-bit cache line number (CL), a 2-bit miss reference number (MR), and four valid bits (B0V, B1V, B2V, B3V), one for each of the four data banks.

When a data entry is read from the return data buffer 428 and sent to the L2 cache RAM 436, a new entry is added to the return request queue 430 to store the cache line address (CL) and the miss count (MR). Additionally, all of the valid bits (B0V, B1V, B2V, B3V) are initialized, for example, by setting all valid bits to “1.”

There are four return request control state machines 432, one for each bank. Each return request control state machine 432 reads the first table entry for which the valid bit has been correspondingly set. For example, the first state machine, which corresponds to the first bank, reads the first entry in which B0V is set to “1”; the second state machine reads the first entry in which B1V is set to “1”; and so on. At each cycle, the state machines then use the cache line address (CL) and the miss count (MR) to search the missed read request table 422 for a match. If there is a match, then the matched entry is processed and the request is sent to the L2 R/W arbiter 434.

For some embodiments, the request that is sent to the L2 R/W arbiter 434 has a lower priority than a write request from the return data buffer 428, but a higher priority than a request from the hit test unit 418. After the request to the L2 R/W arbiter 434 is granted access to the L2 cache RAM 436 for read, the entry is released and marked as invalid (bit set to “0”).

After all matched entries in a given bank (identified by CL and MR) of the missed read request table 422 are processed, the valid bits of the corresponding entries in the return request queue 430 are set to “0.”When all four valid bits of an entry are reset to “0,” the miss post-counter for the line is incremented, and the entry in the return request queue 430 is removed. In other words, when the pending request for all four banks of a particular line are served, the miss post-counter of the line is incremented, and the entry in the return queue 430 is removed.

The return data buffer 428 is searched with the updated miss counter value (MR). If a match is found in the slots for the miss-on-miss requests, then the data entry of the slot is moved into the L2 cache RAM 436, and a new entry is added to the return request queue 430.

As shown with reference to FIGS. 1 through 11, the merging of requests within the L2 cache 210 permit greater processing efficiency, insofar as duplicative requests are reduced from the request queue.

Additionally, the missed read request table 422 and the missed write request table 420 permit faster processing compared to conventional latency FIFOs that suffer from latency problems.

The various logic components are preferably implemented in hardware using any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Although exemplary embodiments have been shown and described, it will be clear to those of ordinary skill in the art that a number of changes, modifications, or alterations to the disclosure as described may be made. For example, while specific bit-values are provided with reference to the data structures in FIGS. 6 through 10, it should be appreciated that these values are provided merely for illustrative purposes. In that regard, the particular configuration of these systems can be altered, and corresponding changes in the bit-values can be implemented to accommodate such configurations.

Additionally, while four-bank embodiments are shown above, it should be appreciated that the number of data banks can be increased or decreased to accommodate various design needs of particular processor configurations. Preferably, any number that is a power of 2 can be used for the number of data banks. For other embodiments, the configuration need not be limited to such numbers.

All such changes, modifications, and alterations should therefore be seen as within the scope of the disclosure.

What is claimed is:

1. A computing system comprising:
an execution unit (EU) pool having multiple execution units; and
a cache operatively coupled to the EU pool, the cache being configured to receive requests from the EU pool, the cache comprising:
means for determining whether there is a hit on the cache that results from a cache read request;
a missed read request table configured to store information related to the read request in response to determining that there is not a hit on the cache that results from the cache read request;
means for determining whether there is a hit on the cache that results from a cache write request; and
a missed write request table configured to store information related to the write request in response to determining that there is not a hit on the cache that results from the cache write request.

2. A cache comprising:
an input configured to receive a cache request;
hit logic configured to determine whether the received cache request results in a hit on the cache;
a missed request table configured to store information related to the received cache request, the information being stored in response to the received cache request not being a hit on the cache; and
output logic configured to service the cache request in response to the received cache request being a hit on the cache.

3. The cache of claim 2, wherein the missed request table is a missed read request table to buffer a missed read request.

4. The cache of claim 3, wherein the missed read request table comprises an entry to identify a cache line associated with the missed read request.

5. The cache of claim 3, wherein the missed read request table comprises an entry to identify a miss reference number associated with the missed read request.

6. The cache of claim 3, wherein the missed read request table comprises an entry to identify a destination associated with the missed read request.

7. The cache of claim 3, wherein the missed read request table comprises an entry to identify an entry type associated with the missed read request.

8. The cache of claim 3, wherein the missed read request table comprises an entry to identify a thread associated with the missed read request.

9. The cache of claim 3, wherein the missed read request table comprises a register file index associated with the missed read request.

10. The cache of claim 3, wherein the missed read request table comprises an entry to identify a task sequence associated with the missed read request.

11. The cache of claim 3, wherein the missed read request table comprises a flag to identify whether the missed read request is valid.

12. The cache of claim 2, wherein the missed request table is a missed write request table to buffer a missed write request.

13. The cache of claim 12, wherein the missed write request table comprises an entry to identify a cache line associated with the missed write request.

14. The cache of claim 12, wherein the missed write request table comprises an entry to identify a miss reference number associated with the missed write request.

15. The cache of claim 12, wherein the missed write request table comprises a flag to identify whether the missed write request is valid.

16. The cache of claim 12, wherein the missed write request table comprises a mask that corresponds to data from the missed write request.

17. A method comprising the steps of:
receiving a cache request;
determining whether the received cache request results in a hit on the cache;
storing information related to the received cache request in response to determining that the received cache request does not result in a hit on the cache; and
servicing the cache request in response to determining that the received cache request results in a hit on the cache.

18. The method of claim 17, wherein the step of receiving the cache request comprises the step of receiving a cache read request.

19. The method of claim 17, wherein the step of receiving the cache request comprises the step of receiving a cache write request.
